(19) United States
(12) Patent Application Publication
(10) Pub. No.: US 2019/0116836 A1
(43) Pub. Date: Apr. 25, 2019

(54) CARBONATED BEVERAGE CONTAINING CARAMEL AND STEVIOL GLYCOSIDE

(71) Applicant: SUNTORY HOLDINGS LIMITED, Osaka (JP)

(72) Inventors: Makoto NAKAJIMA, Kanagawa (JP); Ryota SUZURI, Kanagawa (JP)

(73) Assignee: SUNTORY HOLDINGS LIMITED, Osaka (JP)

(21) Appl. No.: 16/089,953

(22) PCT Filed: Mar. 31, 2017
(86) PCT No.: PCT/JP2017/013585

§ 371 Date: Sep. 28, 2018

(30) Foreign Application Priority Data
Mar. 31, 2016 (JP) 2016-072901

(51) Int. Cl. A23L 2/60; A23L 2/54; A23L 2/40; A23L 2/38

(52) U.S. Cl. CPC A23L 2/60; A23L 2/54; A23V 2250/258; A23L 2/38; A23V 2002/00; A23L 2/40

(57) ABSTRACT

A natural and low-calorie-oriented carbonated beverage has improved bubble dissipation behavior and suppressed foaming. The carbonated beverage satisfies the following conditions: (A) a content of a caramel is 100 to 5000 ppm; (B) a total content of RebD and/or RebM is 200 to 500 ppm; and (C) (total content of RebD and/or RebM)≤(−1/49)×(content of caramel)+502.

### TECHNICAL FIELD

An embodiment of the present invention relates to a carbonated beverage containing a caramel and a steviol glycoside.

### BACKGROUND ART

There is an increasing demand for natural and low-calorie-oriented carbonated beverages. There is known a carbonated beverage containing a steviol glycoside as a natural sweetener (Patent Literature 1). However, low-calorie carbonated beverages may suffer problems concerning bubble dissipation behavior and foaming which are caused by a component or carbonic acid gas contained in the carbonated beverages. Such problems become more serious as the pressure of the carbonic acid gas in the beverages increases. In relation to such problems, incorporation of an anti-foaming agent has been reported as means for reducing the foaming of carbonated beverages (Patent Literature 2). However, this means is not suitable for natural-oriented carbonated beverages.

### CITATION LIST

### Patent Literature

Patent Literature 1: Japanese Patent Laid-Open No. 2015-502404

Patent Literature 2: Japanese Patent Laid-Open No. 2014-087359

### SUMMARY OF INVENTION

### Technical Problem

Through research and development of natural and low-calorie-oriented carbonated beverages, the present inventors have found that bubbles once generated in a carbonated beverage containing a caramel and a steviol glycoside do not readily disappear (bubble dissipation behavior is poor), and that foaming is intense in such a beverage. A further study has led the inventors to the discovery that these phenomena are associated with RebA which is a main steviol glycoside.

The present invention aims to provide a natural and low-calorie-oriented carbonated beverage having improved bubble dissipation behavior and suppressed foaming.

### Solution to Problem

An embodiment of the present invention is a carbonated beverage satisfying the following conditions: (A) a content of a caramel is 100 to 5000 ppm; (B) a total content of RebD and/or RebM is 200 to 500 ppm; and (C) (total content of RebD and/or RebM)≤(−1/49)×(content of caramel)+502.

### BRIEF DESCRIPTION OF DRAWING

FIG. 1 shows the influence of the contents of a caramel and RebD on the bubble dissipation behavior of a carbonated beverage.

### DESCRIPTION OF EMBODIMENT

Hereinafter, an embodiment of the present invention will be described with reference to the drawings.

A carbonated beverage of the embodiment of the present invention contains a caramel and RebD and/or RebM. In the carbonated beverage, the content of the caramel is 100 to 5000 ppm, the total content of RebD and/or RebM is 200 to 500 ppm, and the following relationship is satisfied: (total content of RebD and/or RebM)≤(−1/49)×(content of caramel)+502. The “ppm” as used herein refers to weight/weight (w/w) ppm, unless otherwise specified.

The caramel used in the embodiment of the present invention can be any known caramel. For example, caramels are classified into caramel I, caramel II, caramel III, and caramel IV according to the production method. Any of these caramels may be used in the embodiment of the present invention. These caramels are defined herein according to Japanese Standards of Food Additives (1999). The caramel used in the embodiment of the present invention can be appropriately selected according to the desired color and flavor of the carbonated beverage and in view of cost and availability. The content of the caramel in the carbonated beverage can be 100 to 5000 ppm. The method for measuring the content of the caramel is not particularly limited, and the content of the caramel can be measured, for example, according to Standard Methods of Analysis in Food Safety Regulation, Physics and Chemistry Edition (issued by Japan Food Hygiene Association in 2005) mentioned in WO 2015/015820. This method is used herein for measurement of the content of the caramel, unless otherwise specified.

The term “Reb” is used herein as an abbreviation of Rebaudioside. Reb is known as a sweet component contained in a stevia extract. The stevia extract can be obtained by extraction from stevia dry leaves, followed by purification. Stevia is an Asteraceous perennial plant native to Paraguay in South America, and its scientific name is Stevia Rebaudiana Bertoni. Stevia contains a component having sweetness which is several score times or more that of sucrose and, for this reason, stevia is grown and used as a source of natural sweetener. The types of Reb previously reported include various glycosides such as RebA, RebB, RebC, RebD, and RebE and further include RebM described in National Publication of International Patent Application No. 2012-504552. Among the various types of Reb, RebA is evaluated as a sweetener having a high degree of sweetness and favorable sweetness and is widely used. Examples of methods for obtaining RebA, RebD, and RebM include, but are not limited to: buying on the market; synthesis by organic chemical process or the like; and separation from or purification of a natural product. When RebA, RebD, or RebM is obtained by separation or purification, a stevia extract can be used as a starting material. For example, RebA, RebD, and RebM can be obtained by purification according to a method described in National Publication of International Patent Application No. 2009-517043, a method described in U.S. Pat. No. 8,414,949, and a method described in Foods 2014, 3(1), 162-175; doi: 10.3390/foods 3010162, respectively. RebA, RebD, and RebM may be analyzed by any method, for example, by a high performance liquid chromatograph (HPLC) set under the conditions described in National Publication of International Patent Application No. 2012-504552. This method is used herein for analysis of RebA, RebD, and RebM, unless otherwise specified.

In the embodiment of the present invention, incorporation of RebD and/or RebM can improve caramel-associated poor bubble dissipation behavior of the carbonated beverage, and can also suppress the foaming that may, when the carbonated beverage contains RebA, occur at the time of opening the bottle of the carbonated beverage or pouring the carbonated beverage into a container. The total content of RebD and/or RebM in the carbonated beverage may be 200 ppm or more. The total content of RebD and/or RebM in the carbonated beverage can be adjusted to 500 ppm or less so as to prevent the carbonated beverage from being excessively sweet. The total content of RebD and/or RebM in the carbonated beverage is more preferably 200 ppm or more and 300 ppm or less (200 to 300 ppm). The “total content of RebD and/or RebM” as described herein refers to the total content of RebD and RebM when both RebD and RebM are present, and the conjunction “or” is used to encompass the situation where RebD or RebM is not contained. When a combination of RebD and RebM is incorporated, the mass ratio between RebD and RebM is not particularly limited. For example, the ratio of the mass of RebM to the mass of RebD may be 0.01 to 5, preferably 0.1 to 4, and more preferably 0.3 to 3.

In the embodiment of the present invention, the degree of sweetness of the carbonated beverage can be adjusted to the extent that it is possible to improve the caramel-associated poor bubble dissipation behavior of the carbonated beverage and reduce the foaming that may, when the carbonated beverage contains RebA, occur at the time of opening the bottle of the carbonated beverage or pouring the carbonated beverage into a container. The degree of sweetness of the carbonated beverage can be adjusted by incorporating any one or combination of sweeteners such as a combination of a natural sweetener and an artificial sweetener. In terms of increase in natural orientation, it is preferable to incorporate a larger amount of a natural sweetener. It is more preferable to adjust the degree of sweetness of the carbonated beverage by incorporating only a natural sweetener. Natural sweeteners that can be used include, but are not limited to, glucose, fructose, sucrose, and a high intensity sweetener. The high intensity sweetener is preferred to allow the carbonated beverage to be low calorie. The high intensity sweetener as described herein refers to a sweetener having higher sweetness than sucrose, and examples of the high intensity sweetener include, but are not limited to, stevia-derived sweeteners (such as the above-mentioned stevia extract, RebA, RebB, RebC, RebD, RebE, and RebM), Siraitia grosvenorii extract, and Glycyrrhiza extract.

In the present embodiment, the degree of sweetness of the carbonated beverage is adjusted on the basis of Brix in terms of sucrose. For example, the degree of sweetness of the carbonated beverage is preferably such that the Brix in terms of sucrose is 5.7 to 14.3. The Brix in terms of sucrose can be calculated herein from the content of Reb and the degree of sweetness of Reb relative to that of sucrose. For example, RebA has a degree of sweetness which is 300 times that of sucrose, and RebD and RebM have a degree of sweetness which is 285 times that of sucrose. Thus, the amount of RebA corresponding to Brix 1 in terms of sucrose can be calculated to be 33.1 ppm, and the amount of RebD and RebM corresponding to Brix 1 in terms of sucrose can be calculated to be 35.1 ppm, respectively. That is, if the degree of sweetness of the carbonated beverage is adjusted by using only RebD and/or RebM so that the Brix in terms of sucrose is 5.7 to 14.3, this means that 200 to 500 ppm of RebD and/or RebM is incorporated in the beverage.

In the embodiment of the present invention, the carbonated beverage is low calorie. The low-calorie carbonated beverage has a calorie content of 20 kcal/100 ml or less, and is preferably a zero-calorie carbonated beverage.

Non-limiting examples of the carbonated beverage of the embodiment of the present invention include refreshing beverages, nonalcoholic beverages, and alcoholic beverages. Specific examples include, but are not limited to, sparkling beverages, Coke, Diet Coke, ginger ales, soda pops, and carbonated water having fruit juice flavor. The content of carbonic acid gas in the carbonated beverage can be specified by a gas pressure. The carbonic acid gas pressure in the carbonated beverage is 2.0 kgf/cm² or more and preferably 2.5 kgf/cm² or more at a liquid temperature of 20° C. The upper limit of the gas pressure may, if desired, be set to 5.0 kgf/cm² or less, preferably 4.0 kgf/cm² or less. In the embodiment of the present invention, carbonic acid gas may be generated by fermentation in the beverage or carbonic acid gas may be injected into the beverage. The carbonic acid gas pressure is measured as follows: the beverage conditioned to 20° C. is fixed in a gas internal pressure meter, and the cock of the gas internal pressure meter is opened to expose the beverage to the atmosphere and is then closed, after which the gas internal pressure meter is shaken, and a value is read when the pointer of the meter stops at a certain position. This method is used herein for measurement of the gas pressure or carbonic acid gas pressure, unless otherwise specified. The terms “carbonic acid gas pressure” and “gas pressure” are defined herein to have the same meaning and are interchangeably used.

In the embodiment of the present invention, the carbonated beverage can be packed in a container. The container used may be any form of container made of any material and may be, for example, a glass bottle, a can, a barrel, or a PET bottle.

In the embodiment of the present invention, the carbonated beverage can further contain an aroma component. Examples of the aroma component include, but are not limited to, cinnamaldehyde (C₆H₅CH=CH—CHO, molecular weight: 132.16). Cinnamaldehyde is an aromatic aldehyde known as an aroma component of cinnamon and is available as a flavoring agent. The content of cinnamaldehyde in the carbonated beverage is, for example, but not limited to, 0.5 to 50 ppm, and can be preferably 0.5 to 32 ppm or 1.0 to 20 ppm. The content of the cinnamaldehyde can be measured, for example, by a method using a gas chromatograph and a mass spectrometer. Such a method is used herein for determination of the content of cinnamaldehyde, unless otherwise specified.

In the embodiment of the present invention, the carbonated beverage may contain a flavor. The flavor may be any available flavor, examples of which include, but are not limited to lemon flavor, lime flavor, Japanese plum flavor, strawberry flavor, apple flavor, orange flavor, grapefruit flavor, and grape flavor. The content of the flavor in the carbonated beverage can be adjusted as appropriate and can be adjusted, for example, to 0.01 to 0.5 w/v %.

The beverage according to the embodiment of the present invention may further contain another component usable in drinks and foods unless the other component impairs the effect of the present invention, and examples of the other component include: polyphenols such as catechins; plant extracts; caffeine; sweeteners (including saccharides such as sugar and isomerized liquid sugars and high intensity sweeteners such as aspartame, sucralose, and acesulfame K); flavoring agent; acidulants (such as citric acid, tartaric acid, malic acid, phosphoric acid, and lactic acid); colorants; fruit juices; fruit juice purees; milk; milk products; other flavors; and nutrient supplements (such as vitamins, calcium, minerals, and amino acids). These components may be added singly or in combination of a plurality of these components in the beverage.

A specific embodiment of the embodiment of the present invention will be described hereinafter. The embodiment is described for better understanding of the present invention and is by no means intended to limit the scope of the invention.

Carbonated beverages were prepared by incorporation of predetermined amounts of caramel IV (Sunbrown CA-4 available from San-Ei Gen F.F.I., Inc.) and RebD. For the beverages, the content of the caramel was adjusted to 100 to 5000 ppm, the content of RebD was adjusted to 200 to 500 ppm (Brix in terms of sucrose: 5.7 to 14.3), the carbonic acid gas was adjusted to 2.0 kgf/cm², and the pH was adjusted to 2.8. The flavor and bubble dissipation behavior of the carbonated beverages were evaluated. The evaluation of the flavor of the beverages was conducted by allowing five expert panels to give scores from 1 to 5 points in increments of 0.1 points. A rating of “x” (poor flavor) was given when the average score was less than 3 points, while when the average score was 3 points or more, a rating of “∘” (good flavor) was given. The evaluation of the bubble dissipation behavior of the beverages was conducted as follows. Each of the carbonated beverages prepared as above was sealed in a 100 ml container, which was allowed to stand at 4° C. for 24 hours. After that, the container was opened, and an inverted 500 ml graduated cylinder was fixed on the spout of the container. The graduated cylinder and container were reversed to pour the carbonated beverage into the graduated cylinder. The time from the moment when the rising bubbles reached the maximum height to the moment when the bubbles converged to a constant liquid level was measured as bubble disappearance time. Carbonated beverages as controls were prepared and evaluated in the same manner as above except for using RebA instead of RebD. A rating of “∘” (improved bubble dissipation behavior) was given when the bubble disappearance time of the carbonated beverage of interest was 90% or less of the bubble disappearance time of a carbonated beverage as a control. When the bubble disappearance time of the carbonated beverage of interest was 85% or less of the bubble disappearance time of a carbonated beverage as a control, a rating of “⊚” was given. When the bubble disappearance time of the carbonated beverage of interest was more than 90% of the bubble disappearance time of a carbonated beverage as a control, a rating of “x” (unimproved bubble dissipation behavior) was given.

TABLE 1

| | | | | | | | | | | | | | | |
|---|---|---|---|---|---|---|---|---|---|---|---|---|---|---|
| Caramel | 100 | 100 | 2000 | 2000 | 2000 | 3500 | 3500 | 3500 | 5000 | 5000 | 3000 | 4000 | 3000 | 4000 |
| content | | | | | | | | | | | | | | |
| (ppm) | | | | | | | | | | | | | | |
| RebD | 500 | 200 | 300 | 400 | 480 | 300 | 400 | 480 | 400 | 200 | 440 | 420 | 450 | 450 |
| content | | | | | | | | | | | | | | |
| (ppm) | | | | | | | | | | | | | | |
| Flavor | ◯ | ◯ | ◯ | ◯ | ◯ | ◯ | ◯ | ◯ | ◯ | ◯ | ◯ | ◯ | ◯ | ◯ |
| Bubble | ◯ | ⊚ | ⊚ | ◯ | X | ⊚ | ◯ | X | ◯ | ◯ | ◯ | ◯ | X | X |
| dissipation | | | | | | | | | | | | | | |
| behavior | | | | | | | | | | | | | | |

Table 1 shows that a caramel content of 100 to 5000 ppm was appropriate in terms of flavor. When the caramel content was less than 100 ppm, the carbonated beverage did not suffer the problems concerning the bubble dissipation behavior and foaming (no data are shown herein). When the caramel content was more than 5000 ppm, the flavor of the carbonated beverage was deteriorated (no data are shown herein). The appropriate RebD content in a carbonated beverage was found to be 200 to 500 ppm. When the RebD content was 200 to 300 ppm, the problems concerning the bubble dissipation behavior and foaming were effectively improved. When the RebD content was less than 200 ppm, the problems concerning the bubble dissipation behavior and foaming of carbonated beverages were not able to be improved (no data are shown herein). When the RebD content was more than 500 ppm, the carbonated beverage had excessive sweetness and poor flavor (no data are shown herein). It was also observed that the higher the caramel content was, the lower was the upper limit of the RebD content effective in improving the problems concerning the bubble dissipation behavior and foaming of carbonated beverages. This fact was utterly unexpected. Given that RebD and RebM have analogous chemical structures and the same degree of sweetness, it should be understood that results similar to those described above are obtained when RebM is used instead of RebD to prepare carbonated beverages or when both RebM and RebD are used in combination to prepare carbonated beverages.

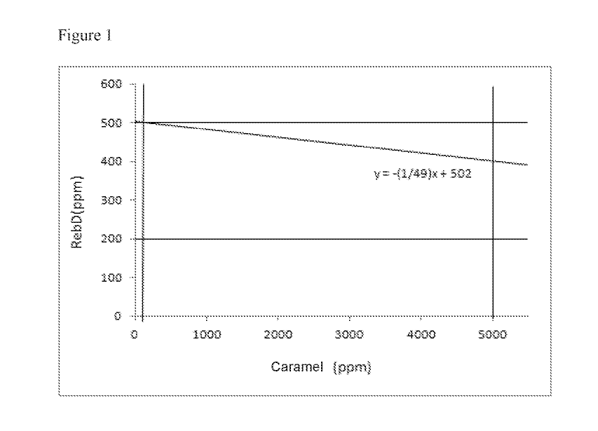

FIG. 1 is one derived from the results shown in Table 1. FIG. 1 reveals that, to improve the bubble dissipation behavior and foaming of carbonated beverages, it is more preferable that the content of the caramel and the content of RebD and/or RebM not only satisfy the following previously described conditions:

the content of the caramel is 100 to 5000 ppm; and

the content of RebD and/or RebM is 200 to 500 ppm,

but also satisfy the following relationship:

(total content of RebD and/or RebM)≤(−1/49)×(content of caramel)+502.

In particular, it was confirmed that the improving effect is enhanced when the RebD content is 200 to 300 ppm.

Tests were conducted under the same conditions as above except for incorporating predetermined amounts of RebM instead of RebD (Table 2). RebM was confirmed to improve the bubble dissipation behavior and foaming of carbonated beverages as effectively as RebD. As is the case for the results shown in Table 1, it was confirmed that the improving effect was enhanced when the RebM content was 200 to 300 ppm.

TABLE 2

| | | | | |
|---|---|---|---|---|
| Caramel content (ppm) | 100 | 2000 | 5000 | 3000 |
| RebM content (ppm) | 200 | 300 | 400 | 450 |
| Flavor | ◯ | ◯ | ◯ | ◯ |
| Bubble | ⊚ | ⊚ | ◯ | X |
| dissipation | | | | |
| behavior | | | | |

It was also confirmed that incorporating predetermined amounts of RebD and RebM in combination improved the bubble dissipation behavior and foaming of carbonated beverages as effectively as incorporating either RebD or RebM singly. In particular, it was confirmed that the mass ratio of RebM to RebD is preferably 0.3 to 3 (Table 3).

TABLE 3

| | | | |
|---|---|---|---|
| Caramel content (ppm) | 100 | 100 | 100 |
| Total amount of RebD | 200 | 200 | 200 |
| and RebM (ppm) | | | |
| RebD amount (ppm) | 100 | 150 | 50 |
| RebM amount (ppm) | 100 | 50 | 150 |
| Flavor | ◯ | ◯ | ◯ |
| Bubble | ⊚ | ⊚ | ⊚ |
| dissipation | | | |
| behavior | | | |

1. A carbonated beverage satisfying the following conditions:
(A) a content of a caramel is 100 to 5000 ppm;
(B) a total content of RebD and/or RebM is 200 to 500 ppm; and
(C) (total content of RebD and/or RebM)≤(−1/49)×(content of caramel)+502.

2. The carbonated beverage according to claim 1, wherein a carbonic acid gas pressure is 2.0 kgf/cm² or more at a liquid temperature of 20° C.

3. The carbonated beverage according to claim 1, wherein the total content of RebD and/or RebM is 200 to 300 ppm.

4. The carbonated beverage according to claim 1, having a calorie content of 20 kcal/100 ml or less.
